(19) United States
(12) Patent Application Publication
(10) Pub. No.: US 2014/0123458 A1
(43) Pub. Date: May 8, 2014

(54) METHOD OF MANUFACTURE AND APPARATUS THEREFOR

(71) Applicants: Corrie W. M. Fearon, Charfield (GB); Geoffrey McFarland, Wickwar (GB)

(72) Inventors: Corrie W. M. Fearon, Charfield (GB); Geoffrey McFarland, Wickwar (GB)

(73) Assignee: RENISHAW PLC, Wotton-under-Edge, Gloucestershire (GB)

(21) Appl. No.: 14/127,104

(22) PCT Filed: Jul. 5, 2012
(86) PCT No.: PCT/GB2012/000569

§ 371 Date: Dec. 17, 2013

(30) Foreign Application Priority Data
Jul. 6, 2011 (EP) 11250638.1

(51) Int. Cl. B23P 25/00

(52) U.S. Cl. CPC B23P 25/00
USPC 29/407.05

(57) ABSTRACT

A method of manufacturing at least one component in at least one component area on a substrate using a machine that has a substrate processing part relatively moveable with respect to the substrate. The method includes, at least when the substrate processing part and substrate are in a positional relationship in which the substrate processing part can process the at least one component area on said substrate, measuring the position of the substrate processing part relative to the substrate, by reading at least a first metro logical scale provided by the substrate.

This invention relates to a method of and apparatus for manufacture, for example manufacturing components such as electrical components, for instance flat panel displays (FPDs).

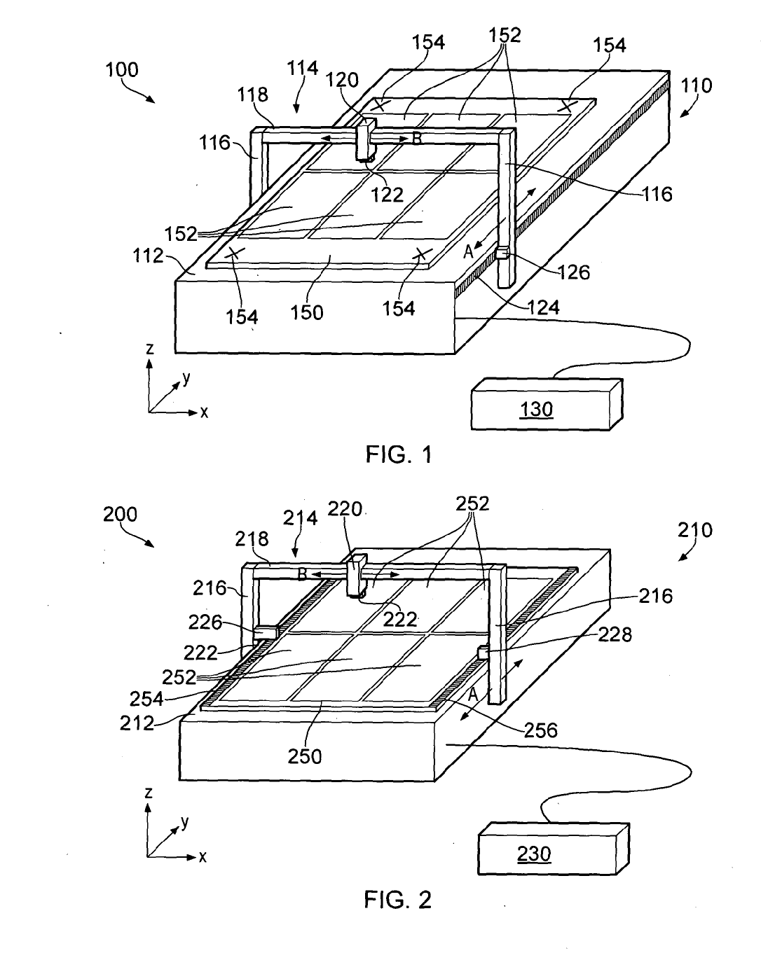

Components such as FPDs are often manufactured in batches, for example a plurality of individual FPDs being made on the same sheet of glass. For example, FIG. 1 provides a schematic illustration of a known apparatus 100 for processing a batch of flat panel displays. In particular, the apparatus comprises a machine 110 for receiving and processing a FPD sheet 150 comprising a plurality of regions 152, each of which is processed by the machine 110 (and in many embodiments a plurality of further machines) during the manufacture of a FPD. The machine 110 comprises a platform 112 onto which the FPD sheet 150 is loaded and a gantry 114 comprising first and second upright pillars 116 and a cross-member 118 extending between them which in turn carries a tool holder 120 onto which a tool 122 (e.g. such as a laser, liquid crystal dispenser or an inspection camera) is loaded. (As will be understood, multiple tools could be mounted on the gantry, e.g. via the one tool holder 120 or via multiple tool holders. Furthermore, multiple gantries can be provided on the one machine). As illustrated by arrow A the gantry 114 can be moved along the platform 112 in the y-dimension by bearings and motors (not shown), and as illustrated by arrow B the tool holder 120 can be moved along the cross-member 118 in the x-dimension by bearings and motors (not shown) under the control of a control system 130. As will be understood, in other embodiments the tool holder 120 could be moved in the z-dimension relative to the cross-member 118, i.e. vertically away from and towards the platform 112. Accordingly, the tool 112 can be moved relative to the FPD sheet 150 in at least two dimensions, for instance at least two substantially orthogonal dimensions.

Position measurement encoders are provided on the machine 110 for determining the relative position of the various movable parts of the machine 110. For example, a metrological scale 124 that extends along the y-dimension is mounted on the side of the platform 112 and a readhead 126 for reading the scale 124 is mounted on the pillar 116 closest to the scale 124. A similar scale and readhead arrangement is provided (but not shown in FIG. 1) for determining the position of the tool holder 120 (and hence the tool 122) relative to the cross-member 118 in the x-dimension. Each of the readheads report their position information back to the control system 130.

Before processing it is necessary to establish the position of the FPD sheet 150 on the machine 110. For this reason a plurality of fiducial marks 154 are provided. As shown, these may be in the form of an X in each corner of the FPD sheet 150. A camera mounted on the tool holder 120 (either in place of or as well as the tool 122, for instance provided as part of the tool) is driven around so as to find the fiducial marks 154 and take a photo of them. The control system 130 uses these fiducial marks to establish the position of the FPD sheet 150 on the machine and to adjust offsets to its program to correct for misalignment. Once the initial position has been found the position of the tool 122 relative to the FPD sheet 150 is tracked using the information from the readheads 126.

US2008/0094593 discloses a wafer processing apparatus, which like that shown in FIG. 1, provides scales which are provided on a part of the apparatus separate to the substrate (i.e. the wafer) to be processed (and in particular is provided on the wafer table that the wafer sits on).

As will be understood, the above process and machine is suitable for making all sorts of flat panel displays such as liquid crystal displays (LCD), light emitting diode (LED) displays, organic light-emitting diode (OLED) displays, plasma displays, and/or electronic paper (including e-paper and electronic ink display devices). Furthermore, similar processes are used during the manufacture of other types of electronic and non-electronic components.

Demands for higher quality, more reliable and cheaper FPDs in turn creates demand for increased accuracy and repeatability in the apparatus and methods used to manufacture FPDs. This is also true for other types of electronic and non-electrical components.

The present invention provides an improved method and apparatus for manufacturing components.

Accordingly, this application describes a method of manufacture, comprising taking a substrate on which at least one component is to be made, in which the relative position of the substrate and at least one substrate processing part is determined via at least a first metrological scale provided by the substrate.

According to a first embodiment of the invention there is provided a method of manufacturing at least one component in at least one component area on a substrate using a machine that has a substrate processing part that is relatively moveable with respect to the substrate, the method comprising: measuring the position of the substrate processing part relative to the substrate at least when the substrate processing part and substrate are in a positional relationship in which the substrate processing part can process the at least one component area on said substrate, by reading at least a first metrological scale provided by the substrate.

It has been found that providing a scale on the substrate itself and using that scale to measure the relative position of the substrate processing part and the substrate whilst they are in a positional relationship in which the substrate processing part can process the at least one component area enables components to be made with greater accuracy. In particular, doing so removes sources of error in the measurement of the relative position of the substrate processing part of the machine and the substrate. This is because, for instance, any lateral movement or offset of the substrate and also any thermal expansion/contraction of the substrate is automatically detected and compensated for by virtue of the machine reading scales that are provided on the substrate itself. Furthermore, in cases in which the substrate is transferred from one apparatus to another for subsequent processing, the scale is transferred with the substrate meaning that for each machine the same scale is used to determine the relative position of the substrate processing part of the apparatus. This helps to ensure consistency and repeatability of processing of the substrate across a plurality of different processing apparatus. This can be especially useful when different machines have different thermal effects on the substrate.

As will be understood, the method can comprise the substrate processing part processing the at least one component area. Processing can comprise inspecting or operating on the at least one component area. Such processing can also comprise relatively moving the substrate and the substrate processing part. This can be at the same time at which the substrate is inspected or operated on, or prior/subsequent to such inspection/operation. Accordingly, such processing can involve relative movement between the substrate processing part and the substrate. The relative position of the substrate processing part and the substrate during such processing can be determined by reading the at least first metrological scale. As will be understood, such processing is distinct from an initial substrate registration process such as those above described prior art methods which establish the position of the substrate on the platform by inspecting fiducials on the substrate. Indeed, such an initial registration process is not necessary when using the method of the invention because the relative position of the substrate and substrate processing part is measured by reading the at least first metrological scale provided by the substrate, thereby giving a direct measurement of their relative position.

At least one position sensor, and in particular at least one position sensor that is fixed relative to the substrate processing part can read the at least first metrological scale.

As will be understood, relative movement between the substrate processing part and the substrate can be effected by moving the substrate, or the substrate processing part or both of them.

Preferably, the method comprises monitoring the relative position, and for example monitoring relative movement, of the substrate processing part and substrate using the at least first metrological scale.

As will be understood, the method can also comprise measuring the position of the substrate processing part relative to the substrate by reading the at least first metrological scale, even when they are not in a positional relationship in which the substrate processing part can process the at least one component area. The method can comprise measuring the position of the substrate processing part relative to the substrate by reading the at least first metrological scale, in a plurality of different relative positions. Optionally, at least one of the relative positions is when the substrate processing part and substrate are in a positional relationship in which the substrate processing part can process the at least one component area, and at least one of the relative positions is when they are not in such a positional relationship.

The method can comprise using the first metrological scale to control the relative movement of the substrate processing part of the machine and the substrate. For instance a control system can use information from the first metrological scale to control the relative movement. In particular, the method can comprise a control system receiving position information from a position sensor reading the at least first metrological scale, e.g. as the substrate processing part and substrate move relative to each other. The control system can then control the relative movement of the substrate processing part of the machine and the substrate based on said position information. In particular, the control system can be configured to issue instructions to the machine so as to effect relative movement of the substrate processing part of the machine and the substrate based on said position information. Accordingly, the at least first metrological scale can be used in the machine's feedback, e.g. servo, loop for controlling the relative movement of the substrate processing part and the substrate.

The at least first metrological scale could extend in at least a first dimension. Accordingly, the method could comprise at least when the substrate processing part and substrate are in a positional relationship in which the substrate processing part can process the at least one component area on said substrate, measuring in at least a first dimension the position of the substrate processing part relative to the substrate, by reading at least a first metrological scale provided by and that extends along the substrate in the first dimension

Accordingly, the at least first metrological scale can be used to measure the relative position of the substrate processing part of the machine and the substrate in said first dimension. Preferably, the at least first metrological scale can be used to measure the relative position of the substrate processing part of the machine and the substrate in said first dimension, across the entire extent of the at least one component area in the first dimension. The length of the at least first metrological scale in said first dimension can be at least the length between the outermost boundaries of said at least one component area in the said first dimension. Of course, as will be understood, the at least first metrological scale in the first dimension could be provided by a single continuous scale or by a plurality of sub-scales extending along the first dimension (e.g. in-line with each other or staggered with respect to each other).

Accordingly, preferably for at least all relative positions in which the substrate processing part of the machine can process the at least one component area, the at least first metrological scale can be read so as to measure the relative position of the substrate processing part and substrate in said first dimension.

The substrate could comprise only a single component area. Optionally, the substrate can comprise a plurality of component areas.

For at least the area defined by the plurality of component areas, the at least first metrological scale can be used to measure the relative position of the substrate processing part of the machine and the substrate in said first dimension.

Preferably, the at least first metrological scale can be used to measure the relative position of the substrate processing part of the machine and the substrate in said first dimension, across the entire extent of the area defined by the plurality of component areas in the first dimension. The length of the at least first metrological scale in said first dimension can be at least the length between the outermost boundaries of said plurality of component areas in the said first dimension.

The plurality of component areas could be described as an array of component areas. The component areas could be arranged regularly or irregularly within the array. The array could be one dimensional or two dimensional. For at least the area defined by the array of component areas, the at least first metrological scale can be used to measure the relative position of the substrate processing part of the machine and the substrate in said first dimension. The length of the at least first metrological scale in said first dimension can be at least the length between the outermost boundaries of said array of component areas in the said first dimension.

Accordingly, preferably for at least all relative positions in which the substrate processing part of the machine can process the at least plurality of (e.g. the array of) component areas, the at least first metrological scale can be read so as to measure the relative position of the substrate processing part and substrate in said first dimension.

The method can comprise for at least first and second positional relationships in which the substrate processing part can respectively process first and second component areas on said substrate, measuring the position of the substrate processing part relative to the substrate by reading at least a first metrological scale provided by the substrate. Accordingly, preferably the at least first metrological scale can be used to measure the relative position of the substrate processing part and the substrate for at least the area defined by the array of component areas in at least a first dimension. Accordingly, the length of the at least first metrological scale in said first dimension can be at least the length between the outermost boundaries of said array in the said first dimension.

The method can comprise forming said first metrological scale on said substrate. This can be performed before said substrate is loaded onto the machine. Optionally, this can be performed whilst the substrate is on the machine. Forming said first metrological scale can comprise putting said metrological scale onto the substrate. Optionally, this can comprise securing a pre-made scale onto the substrate.

Preferably, the at least first metrological scale is provided by marks directly on and/or in the substrate (i.e. as opposed to marks on or in another intermediate material which is then secured onto the substrate). Accordingly, optionally, forming said first metrological scale can comprise forming a series of marks in the substrate. For example, this can comprise using a laser to form marks in the substrate, e.g. so as to ablate parts of the substrate thereby marking the substrate. Optionally, for example, this can comprise printing the metrological scale onto the substrate. Optionally, photolithographic techniques, chemical blacking, chemical etching, laser etching or other techniques can be used to form the metrological scale.

The at least first metrological scale can be formed on the substrate in a temporary state. Accordingly, the method can further comprise removing the at least first metrological scale from the substrate. Optionally, the at least first metrological scale can be formed on the substrate in a permanent state. For instance, the metrological scale can be formed so as to be an integral part of the substrate.

The at least first metrological scale could be provided on the upper face of the substrate; that is the same side of the substrate that faces and is processed by the substrate processing part of the machine. Optionally, the at least first metrological scale is provided on the lower face of the substrate; that is the side of the substrate that faces away from the substrate processing part of the face. Further optionally, the at least first metrological scale is provided on the rim of the substrate that extends between the upper and lower faces of the substrate.

The position sensor for reading the at least first metrological scale could be configured to read the at least first metrological scale from the same side of the substrate on which the first metrological scale is provided. Optionally the position sensor could be configured to read the at least first metrological scale from the opposite side of the substrate on which the at least first metrological scale is provided. For instance, the position sensor could be configured to read the at least first metrological scale through the substrate.

The machine can comprise at least one support on which the substrate can be loaded. The at least one support could comprise a platform on which the substrate can be supported. Optionally, the at least one support could comprise at least two reels between which the substrate is supported and passed. The machine can further comprise an arm, for example a gantry, moveable relative to the at least one support. The arm can carry the substrate processing part of the machine. The arm can be moveable relative to the at least one support in a linear dimension. Preferably, the method comprises the arm and hence the substrate processing tool moving relative to the substrate loaded on the at least one support in a dimension substantially parallel to the first dimension along which the at least first metrological scale extends. Optionally, the position sensor for reading the at least first metrological scale is provided on the arm of the machine. In particular, the position sensor could be provided on a vertical pillar of the arm. Optionally, the position sensor is provided in or on the at least one support of the machine. Optionally, the position sensor is mounted on the machine such that it can move between a reading position at which the position sensor can read a first metrological scale on a substrate loaded onto the at least one support and a retracted position at which the position sensor is retracted so as to facilitate loading and unloading of the substrate onto the at least one support. The position sensor could be provided on a position sensor supporting arm attached to the machine. The position sensor supporting arm could be configured such that it can pivot the position sensor between the reading and retracted positions.

The at least first metrological scale can comprise a series of position markings that, for example, define an incremental scale. The series of markings could comprise at least one reference mark defining a reference position along the length of the at least first metrological scale. The series of position markings can define an absolute scale. That is the series of position markings could comprise a series of absolute position markings. As will be understood, a series of absolute position markings define a plurality of unique positions along the length of the scale. In other words, such a scale typically has a plurality of features which encode unique position data along the measurement direction of the scale. Accordingly, this enables the relative position between the scale and the position sensor reading the scale to be determined without requiring relative movement between the two (unlike the case with an incremental scale). Often, absolute position markings are provided in the form of code-words, such as a series of unique code-words, extending along the length of the scale. Optionally, an absolute scale can comprise a series of position markings that define unique position information at each point along the entire extent of the scale. Accordingly, the position of a device reading the absolute series of position markings relative to the series of position markings can be determined from a single reading only at any point along the length of the series of position markings.

Preferably the series of position markings are provided in a single track. However, as will be understood this need not necessarily be the case and can be provided in more than one track. Furthermore, one track can comprise absolute position markings and the other incremental position markings.

Preferably, there is provided a substantially continuous series of position markings.

The method can further comprise creating an error map and/or error function for said first metrological scale. This can be performed before said substrate is loaded onto the machine. Optionally, this can be performed whilst the substrate is on the machine. As will be understood, an error map and/or error function can be used to correct any errors in the position information provided by the scale, e.g. due to irregular spacing of at least some of the features on the scale. The method can then further comprise using said error map and/or error function to correct measurements of the relative position of the substrate processing part of the machine and the substrate. The error map and/or error function could be used with and/or combined with any pre-determined error map and/or error function for the machine which could be used to correct all sorts of different types of sources of error in the machine such as orthogonality of the different movement axes, straightness of a movement axis and/or for example errors due to any non-flatness of the machine's platform on which the substrate is supported.

Creating an error map and/or error function for the at least first metrological scale can comprise comparing position readings taken from the at least first metrological scale with position readings taken from a calibration position measuring system. The calibration position measuring system can be a pre-calibrated position measuring system. The calibration position measuring system can be a laser interferometer. The position readings taken from the at least first metrological scale and the position readings taken from a calibration position measuring system can both relate to the position of the same part of a machine (e.g. the part on which a position sensor for reading the at least first metrological scale is located). The machine can be the aforementioned machine on which the substrate is loaded for processing. Optionally, the machine can be a different machine. For instance the machine could be a testing machine.

The method can comprise at least when a second substrate processing part and the substrate are in a positional relationship in which the second substrate processing part can process the at least one component area on said substrate, measuring the position of the second substrate processing part relative to the substrate, by reading at least a first metrological scale provided by the substrate. The metrological scale read to determine the relative position of the second substrate processing part can be same as that read to determine the relative position of the aforementioned substrate processing part. As will be understood, the second substrate processing part could be the next substrate processing part in line in a series of substrate processing parts for processing the at least one substrate. Optionally, there are other substrate processing parts. These could be used to process substrate, before, after or between the aforementioned substrate processing part and the second substrate processing part. Accordingly, the method can comprise a plurality of substrate processing parts processing the at least one component area, in which for at least some of the substrate processing parts, their relative position to the substrate at least when they are in a positional relationship in which they can process the at least one component area is measured by reading the at least first metrological scale.

The method can comprise the second substrate processing part processing the at least one component area (e.g. so as to inspect or operate on the at least one component area). As will be understood, features described above are equally applicable to the second substrate processing part.

The second substrate processing part can be provided by a second machine. Accordingly, the method can comprise subsequently loading said substrate onto a second machine.

The error map and/or error function for the at least first metrological scale can be used to correct measurements of the relative position of the substrate and the substrate processing parts of by each of the aforementioned and second substrate processing parts (and/or machines), and any further substrate processing parts (and/or machines). The error map and/or error function could be stored in memory associated with each machine. Optionally, the error map and/or error function could be stored in at least one server remote from said machine(s) and the method can comprise retrieving the error map and/or error function from the at least one remote server. Optionally, the error map and/or error function could be stored on the machine which was used in the generation of the error map and/or error function. Accordingly, the method could comprise the second machine retrieving the error map and/or error function for the at least first metrological scale from the at least one remote server

The substrate can comprise at least a second metrological scale. The second metrological scale can extend substantially parallel to the first metrological scale. For example, they can both extend along the substrate in a first dimension. The at least second metrological scale can be spaced apart from the at least first metrological scale. Accordingly, in line with the above the at least second metrological scale can also or instead be read to measure the relative position of the substrate processing part and the substrate at least when they are in a positional relationship in which the substrate processing part can process the at least one component area. Accordingly, the method can comprise a control system receiving position information from a position sensor on the machine reading the at least second metrological scale. Accordingly, there can be provided at least a second position sensor on the machine for reading the at least second metrological scale. As will be understood, the above mentioned features in connection with the at least first metrological scale are also appropriate and equally applicable to the at least second metrological scale.

The substrate can comprise at least a first auxiliary metrological scale. The at least first auxiliary metrological scale can extend in a different dimension to the at least first metrological scale. The at least first auxiliary metrological scale can extend orthogonally to the at least first metrological scale. For example, the at least first auxiliary scale can extend along the substrate in a second dimension. The second dimension can be orthogonal to the first dimension. As will be understood, even if the at least first auxiliary metrological scale doesn't extend orthogonal to the first metrological scale, then position information in a dimension orthogonal to the at least first metrological scale can be resolved from the at least first auxiliary metrological scale. The method could comprise establishing the location of the substrate using the at least first auxiliary scale. The method could comprise establishing the relative position of the substrate processing part of the machine and the substrate in the second dimension using the at least first auxiliary scale. Optionally, the at least first auxiliary scale is used to determine, and for example monitor, the relative position of the substrate processing part of the machine and the substrate in the second dimension. Accordingly, the method can comprise using the first auxiliary scale to control the relative movement of the substrate processing part of the machine and the substrate. For instance a control system can use information from the first auxiliary scale to control the relative movement. Accordingly, the method can comprise a control system receiving position information from a position sensor on the machine reading the at least first auxiliary metrological scale, and controlling the relative movement of the substrate processing part of the machine and the substrate based said position information. The at least first auxiliary metrological scale could extend only part way across the substrate in the second dimension. The length of the at least first auxiliary metrological scale in said second dimension could be at least the width defined by outermost boundaries of the at least one component area taken in the second dimension. The at least first auxiliary metrological scale could extend across the entire width of the substrate in the second dimension. In particular, in embodiments in which there are a plurality of component areas, the first auxiliary metrological scale can be used to monitor the relative position of the substrate processing part of the machine and the substrate in said second dimension during said processing of at least one of the at least one component areas. The length of the at least first auxiliary metrological scale in said second dimension can be at least the length between the outermost boundaries of said plurality of component areas in the said second dimension. As will be understood, the features described above in connection with the at least first metrological scale are also equally relevant and applicable to the at least first auxiliary metrological scale.

Accordingly, as is clear from the above, the at least first metrological scale (and optionally at least second metrological scale and/or at least first auxiliary scale) can be used to determine, and for example monitor, the relative position of the substrate and a substrate processing part of the machine during processing of at least one of the at least one flat panel display areas. Processing the substrate, or more particularly at least one component area, can comprise at least one of inspecting at least one of the at least one component areas; and interacting with so as to alter at least one of the at least one component areas. Inspecting could comprise obtaining at least one image of at least one of the at least one component areas, e.g. so as to identify the location of features/defects for measurement or other purposes, e.g. in the case of flat panel displays for measuring the quality of pixels and/or parameters of a component being made. Interacting with so as to alter at least one of the at least one component areas could comprise performing an additive, subtractive or manipulative process on the at least one component area, e.g. in the case of flat panel displays this could comprise injecting liquid crystal into a pixel, and/or laser processing so as to alter or remove a pixel.

The at least first metrological scale can extend in first and second dimensions, in particular first and second orthogonal dimensions. Accordingly, the at least first metrological scale could be a two-dimensional scale.

Optionally, the machine can comprise a secondary position measuring system for determining the position of the substrate processing part and the substrate (for example in the at least first dimension). In particular, the secondary position measuring system can be configured to determine, for example monitor, the relative position of the substrate processing part and/or another part of the machine, for instance the at least one support on which the substrate is loaded. The secondary position measuring system can provide such position information to a coarser degree of accuracy than that provided by using the at least first metrological scale.

The substrate can comprise a sheet on which at least one component can be made. The substrate could comprise a panel or board of material onto which a component is to be made. For example, the substrate can be a flat panel display sheet comprising at least one flat panel display area which is to be made into a flat panel display. The panel or board, could be substantially rigid.

The substrate could be a flexible substrate. This is especially the case when the substrate is supported by and passed between a plurality of reels, e.g. in a reel-to-reel processing machine. Accordingly, the substrate could be provided on a reel. Accordingly, the substrate can be unrolled from the reel during the manufacture of the at least one component and passed between a plurality of reels. The substrate processing part can process the unrolled substrate.

As mentioned above, the scale could be provided by the substrate in a number of suitable manners. For instance, the pre-made scale could be secured onto the substrate. In this case, the scale is optionally made from the same material as the substrate, but this need not necessarily be the case. In such as case, preferably the scale is mastered to the substrate such that the thermal expansion/contraction of the substrate dominates over any such thermal expansion/contraction of the scale. That is, the scale can be slaved to thermally induced expansion/contraction of the substrate. In other words, preferably the effect of thermal expansion of the substrate on the scale is greater than that of the scale on the substrate, and in particular, preferably at least 50 times greater, especially preferably at least 100 times greater.

Accordingly, this application also describes a method of manufacturing a component comprising: taking a substrate comprising at least one component area, the substrate having at least a first metrological scale comprising a series of position markings extending along the substrate; in which the at least first metrological scale is used to monitor the relative position of the substrate and a substrate processing part of a machine that is used to process at least one of the at least one component areas.

According to a second aspect of the invention there is provided an apparatus for manufacturing at least one component on a substrate, comprising: a machine for receiving a substrate comprising at least one component area in which a component is to be made, the machine comprising a substrate processing part for processing the at least one component area, the substrate processing part and substrate being movable relative to each other such that they can be moved into a positional relationship in which the substrate processing part can process the at least one component area on said substrate; at least one position sensor configured such that when the substrate processing part and substrate are in such a positional relationship, the position sensor can read a scale provided by the substrate; and a control system configured to receive such readings from the at least one position sensor and to measure the relative position of the substrate processing part and the at least one component area.

The control system can also be configured to control relative movement of the substrate processing part and the substrate during said processing.

According to a third aspect of the invention there is provided a substrate comprising at least a first metrological scale provided by the substrate, for use in any of the above described the methods or apparatus.

According to a fourth aspect of the invention there is provided a substrate comprising at least one component area which is to be made into at least one component, the substrate having at least a first metrological scale extending along the substrate in a first dimension by at least the same length as the length of the at least one component area taken in the first dimension such that the at least first metrological scale can be read when a substrate processing part is in a positional relationship relative to the substrate for processing the at least one component area so as to measure their relative position. Accordingly, the metrological scale can be used during the processing of at least one of the at least one component areas to monitor the relative position of a substrate processing part of a machine on which the substrate is loaded and the substrate in said first dimension.

As above, the substrate can be a flat panel display sheet comprising at least one flat panel display area which is to be made into a flat panel display.

According to another aspect of the invention there is provided a method of manufacturing at least one component in at least one component area on a substrate comprising forming at least a first metrological scale (for reading by a readhead) on the substrate. Preferably, the at least a first metrological scale extends along the substrate in a first dimension by at least the same length as the length of the at least one component area taken in the first dimension. As mentioned above, the scale could be formed before the substrate is loaded onto a machine for processing the component. Optionally, this can be performed whilst the substrate is on the machine. Forming said first metrological scale can comprise putting said metrological scale onto the substrate. This can comprise putting marks directly on and/or in the substrate. For example, this can comprise printing the metrological scale onto the substrate. Optionally, forming said first metrological scale can comprise forming a series of marks in the substrate. For example, this can comprise using a laser to form marks in the substrate, e.g. so as to ablate parts of the substrate thereby marking the substrate. Optionally, putting said metrological scale onto the substrate can comprise securing a pre-made scale onto the substrate.

This application also describes a method of manufacture, comprising: generating an error map and/or error function for a metrological scale located on a substrate; loading the substrate onto at least one machine for processing, the machine using the substrate's scale during processing of the workpiece; and supplying the error map and/or error function for the substrate's scale to the at least one machine for use during said processing. The error map and/or error function can be used to correct measurements obtained from the metrological scale. Optionally, during manufacture of the substrate, the substrate can be loaded onto a plurality of machines which use the substrate's scale during processing of the workpiece. The method can comprise supplying the error map and/or error function to a plurality of those machines for use during processing of said substrate. Each machine could retrieve the error map and/or error function from memory local to the machine when needed, e.g. when the substrate is loaded on the machine. Optionally, the error map and/or error function could be stored on a remote server and the error map and/or error function could be retrieved from the remote server when needed, e.g. when the substrate is loaded on the machine. As will be understood, the substrate can be a flat panel display sheet, in particular a flat panel display sheet such as one described in more detail above and below.

Embodiments of the invention will now be described, by way of example only, with reference to the accompanying drawings, in which:

FIG. 1 shows a schematic isometric view of a known machine for processing a flat panel display sheet;

FIG. 2 is a schematic isometric view of a machine for processing a flat panel display sheet according to one embodiment of the invention;

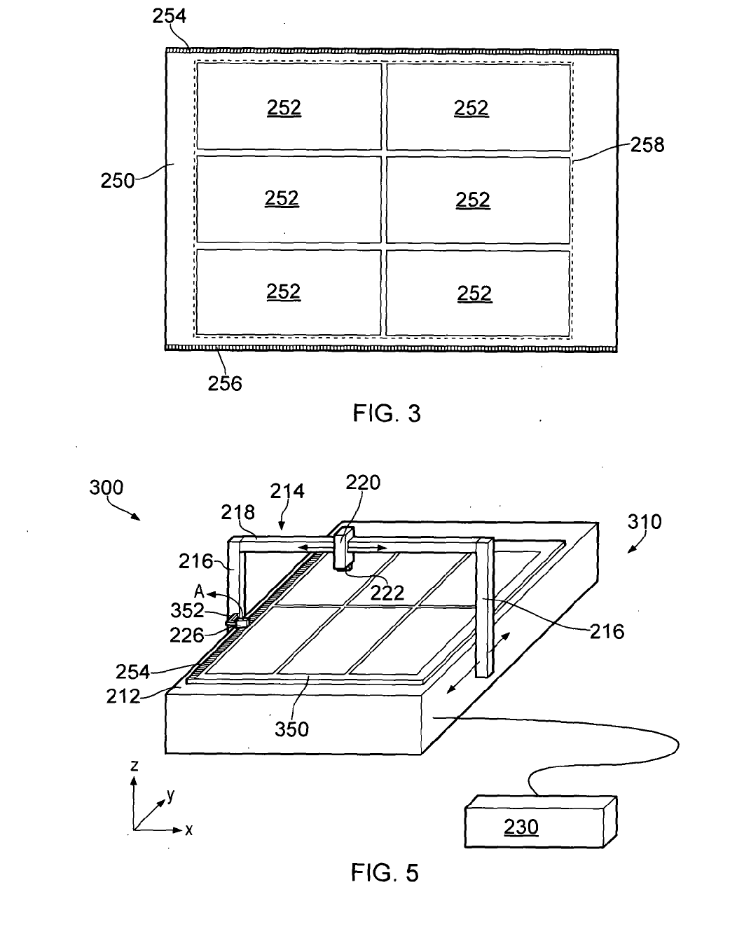

FIG. 3 is a plan of a flat panel display sheet according to one embodiment of the invention;

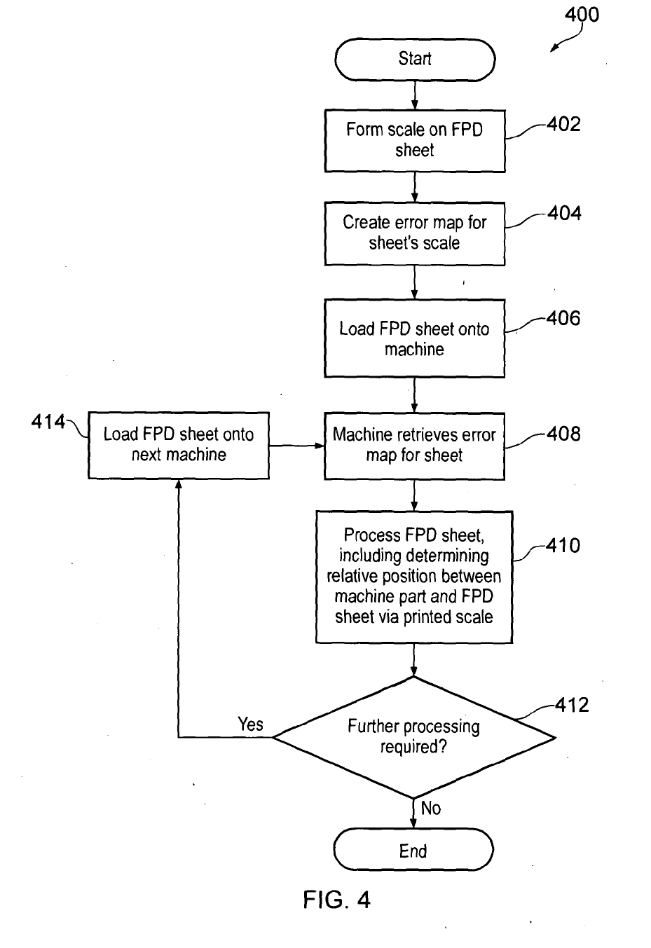

FIG. 4 is a flow chart illustrating the steps involved in processing a flat panel display sheet according to one embodiment of the invention;

FIG. 5 is a schematic isometric view of a machine for processing a flat panel display sheet according to another embodiment of the invention;

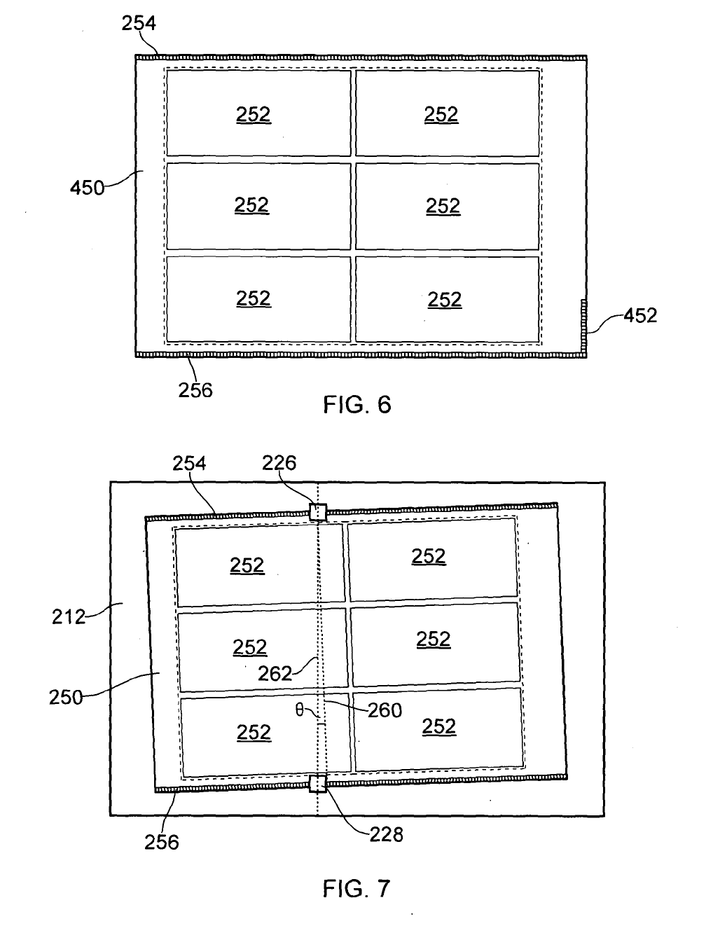

FIG. 6 is a plan view of a flat panel display sheet according to another embodiment of the invention;

FIG. 7 is a plan view of a flat panel display sheet according to an embodiment of the invention, mounted at an angle on the platform of a machine;

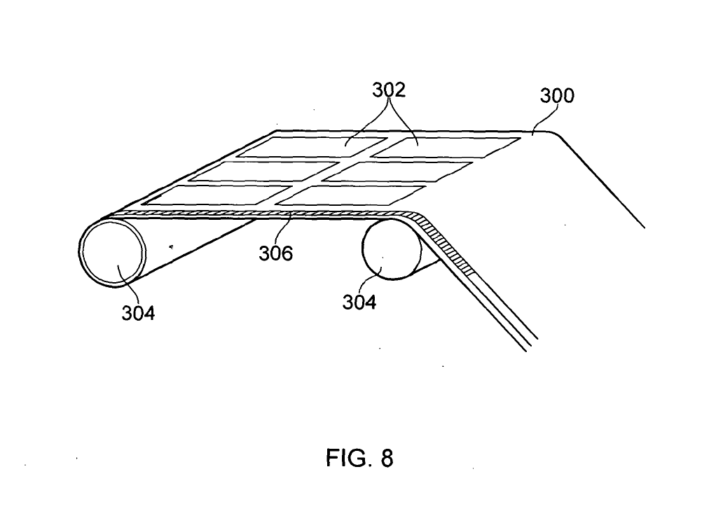

FIG. 8 is a schematic isometric view of a flexible substrate on which a plurality of components are made in a reel-to-reel process.

Referring now to the figures, FIG. 1 provides a schematic illustration of a known apparatus 100 for processing a batch of components, in this particular example a batch of flat panel displays. The apparatus 100 of FIG. 1 has already been described in detail above in connection with the background of this invention and so no further description is given here.

FIG. 2 provides a schematic illustration of an apparatus 200 according to the present invention. As shown, like with the apparatus of FIG. 1, the apparatus 200 comprises a machine 210 for receiving and processing a substrate, e.g. glass FPD sheet 250. As will be understood, the FPD sheet 250 can be made from materials other than glass, for instance plastic, and of course can be made from composite materials. The FPD sheet 250 comprises a plurality of regions 252 each of which is processed by the machine 210 (and in many embodiments a plurality of further machines) to form a FPD (but as will be understood, the invention is also suitable for use in the manufacture of components other than flat panel displays, for example electronic circuit boards and/or flexible electronic circuits. As will be understood, processing can comprise one or more of many different tasks. For instance, processing the FPD sheet 250 can comprise: injecting liquid crystal into individual cells/pixels in one or more of the regions 252; inspecting one or more of the regions 252 for faults/defects, for instance via obtaining at least one image of at least a part of a region 252; and/or repairing at least a part of a region 252, e.g. using a laser to remove a broken pixel. The machine 210 comprises a platform 212 onto which the FPD sheet 250 is loaded and a gantry 214 comprising first and second upright pillars 116 and a cross-member 218 extending between them which in turn carries a tool holder 220 onto which a substrate processing part, e.g. tool 222 (e.g. such as a laser or an inspection camera) is loaded. As mentioned above in connection with prior art machines, multiple tools could be mounted on the gantry, e.g. via the one tool holder 120 or via multiple tool holders. Furthermore, multiple gantries can be provided on the one machine. As illustrated by arrow A the gantry 214 can be moved along the platform 212 in the y-dimension by bearings and motors (not shown) and as illustrated by arrow B the tool holder 220 can be moved along the cross-member 218 in the x-dimension by bearings and motors (not shown) under the control of a control system 230. As will be understood, in other embodiments, the tool holder 120 could be moved in the z-dimension relative to the cross-member 118, i.e. vertically away from and towards the platform 112. Accordingly, the tool 222 can be moved relative to the FPD sheet 250 in at least two orthogonal dimensions.

Position measurement encoders are provided for determining the relative position of the various movable parts of the machine 210. For example, although not shown, a readhead and scale arrangement are provided on the tool holder 220 and cross-member 218 to enable their relative position in the x-dimension to be reported back to the control system 230. Unlike the embodiment shown in FIG. 1, there is no scale mounted on the side of the platform 212 for enabling measurement of the position of the gantry 214 relative to the platform 212 in the y-dimension. Rather, as shown in FIG. 2 (and also in FIG. 3) first 254 and second 256 metrological scales are provided on the top face of the FPD sheet 250 that extend in a first dimension along opposing edges of the FPD sheet 250. Each of the first 254 and second 256 scales comprise a series of absolute position markings. In the described embodiment, the series of markings in the first scale 254 is identical to the series of markings in the second scale 256, although this need not necessarily be the case.

Furthermore, as can be seen from FIG. 2, there is provided a first readhead 226 mounted on the inside of one of the pillars 216 and a second readhead 228 mounted on the inside of the other of the pillars 216, such that when the FPD sheet 250 is loaded onto the machine 210 platform 212, the first readhead 226 is located in a reading position over the first scale 254 and the second readhead 228 is located in a reading position over the second scale 256. Accordingly, the relative position of the gantry 214 (and hence the tool 222) and the FPD sheet 250 in the y-dimension can be determined and monitored via the outputs of the first 224 and second 228 readheads.

The position of the tool 222 relative to the FPD sheet 250 in the dimension parallel to the length of the first 254 and second 256 scales (i.e. in the y-dimension in the set up shown in FIG. 2) can be monitored for the entire area defined by the array of FPD areas 252 in the dimension parallel to the length of the first 254 and second 256 scales. This is because, as shown, the first 254 and second 256 scales are at least as long as the length of the area defined by the FPD areas 252 (illustrated by the area enclosed by dotted line 258) taken in the dimension parallel to the length of the first 254 and second 256 scales. In fact, in the described embodiment described and shown, the first 254 and second 256 scales extend the entire length of the FPD sheet 250.

If desired, an additional position measurement encoder for determining the position of the gantry 214 relative to the platform 212 could be provided, e.g. on the gantry 214 and platform 212 so that their position can be determined. For example, an additional readhead and scale configured similar to that shown in FIG. 1 could be provided. This enables the position of the gantry 214 relative to the platform 212 to be determined even when there is no FPD sheet 250 loaded on the platform 212. It can also be used to determine when the gantry 214 is getting close to the ends of the platform 212. Optionally, it can also be used to drive the tool 222 into the region of the flat panel display area that is to be processed. However, even in such a case the control system 230 will use the readings from the readheads 226, 228 that read the scales 254, 256 on the FPD sheet 250, at least at some point when the tool 222 is in a position in which it can process the flat panel display area, as this provides more accurate and repeatable positioning of the tool 222 relative to the flat panel display area being processed. For example, if the tool 222 is an imaging unit, then readings from the scales 254, 256 on the FPD sheet 250 could be taken at the relative position of the FPD sheet 250 and tool 222 at which an image is taken, so that an accurate determination of the relative position of the tool 222 and the FPD sheet can be made. In an alternative embodiment, for instance when the tool 222 is a tool for operating on at least one flat panel display area, readings from the additional position measurement encoder the tool 222 could be used to provide feedback to a control system when the tool 222 is being moved into the vicinity of the flat panel display area to be proceed, but when it is in a position in which it can operate on the flat panel display area, measurements of the relative position of the tool 222 and the FPD sheet 250 can be taken from the scales 254, 256 on the FPD sheet 250 and used to control the relative position of the tool 222 and the FPD sheet 250 in order to give greater, more accurate control over their relative position. Accordingly, as the scales 254, 256 on the FPD sheet 250 itself are used during critical moments to ensure accurate relative positioning, such an additional position measurement encoder can be much cheaper and coarser than that provided on the machine of FIG. 1. Indeed, such a position measurement could even be provided by hall sensors on the motor(s) which effect movement of the gantry 214 relative to the platform in the y-dimension.

The steps involved in an example process 400 for manufacturing a FPD according to the invention are illustrated in FIG. 4. The process 400 begins at step 402 at which the first 254 and second 256 scales are formed on the FPD 250 along its opposing edges (i.e. as illustrated in FIGS. 2 and 3). This could be put onto the glass FPD sheet 250 using standard known processes for applying scale markings onto glass substrates. For instance, a photolithographic process could be used in which a metal material (e.g. chromium) is deposited onto the FPD sheet, which is then covered by a layer of resist material. Photolithography can then be used to selectively cure parts of the resist and then the uncured parts are washed off. An etching process can then be used to etch the chromium that is exposed and after the etching step the remaining resist is removed. What is left is a scale that has low reflective features (where the chromium was etched) and (relatively) high reflective features where the chromium was covered by the resist during the etching step. As will be understood, many other techniques can be used to put scale markings on the FPD sheet. For instance, a laser could be used to form the scale markings in the FPD glass via ablation, such as using the techniques described in International Patent Application no. PCT/GB03/00266 (Publication no. WO 03/01891). Other alternative methods could include printing material, e.g. reflective ink, directly onto the FPD sheet 250.

Once the first 254 and second scale 256 scales have been put onto the FPD sheet 250, the FPD sheet 250 is then passed to a testing machine. (However, as will be understood the machine for forming the scales and the testing machine can be the same machine. Indeed, the same machine could also be used to process the FPD sheet). The testing machine is similar to that shown in FIG. 2 in that it has a platform for receiving the FPD sheet 250 and first and second readheads that can move along the platform in a similar to those shown in FIG. 2 on the gantry, for reading the first 254 and second 256 scales on the FPD sheet loaded on the platform. However, it also has an additional pre-calibrated device for measuring the position of the readheads relative to the platform. For example, at least one additional readhead and scale setup might be provided (e.g. like that shown in FIG. 1). Optionally, a laser interferometer system might be provided for accurately tracking movement of the first (and second) readhead(s) relative to the platform. The FPD sheet loaded on the platform is held stationary relative to the platform, and movement of the first (and second) readhead(s) relative to the FPD sheet is measured via the first 254 and second 256 scales. The measurements obtained via the first 254 (and second 256) scale(s) are compared to measurements provided by the additional measuring device (e.g. the laser interferometer). Any errors between the two can be assumed to be due to errors in the scale printed on the FPD sheet and so an error map and/or error function for the FPD sheet can be generated and stored for later use as described in more detail below. For instance, the error map and/or error function can be stored in a central server or database which can be in communication with each of the machines used to process the FPD sheet.

After the error map and/or error function has been generated for the FPD sheet 250, the method proceeds to step 406 at which point the FPD sheet 250 is loaded onto the machine 210. This could be done manually, e.g. via an operator controlling the lifting of the FPD sheet 250 from the testing machine via hand, or with the aid of machinery, and placing the FPD sheet 250 onto the machine 210 which is to process the FPD sheet 250. Optionally, this could be done automatically. For instance, the FPD sheet 250 could be transported from the testing machine to the machine for processing the FPD sheet 250 via a suitable transit mechanism such as a robot arm configured to pickup, move and place down the FPD sheet 250.

At step 408 the machine 210 retrieves the error map and/or error function for the FPD sheet 250 loaded onto it. (As will be understood, the error map and/or error function could be retrieved before, after or whilst the FPD sheet 250 is loaded onto the machine). In the embodiment described the error map and/or error function is retrieved from a central server which stores all error maps and/or error functions for all of the FPD sheets that the machine is to process. Of course other implementations are possible. For instance the machine 210 can itself store the error map and/or error function for the FPD sheet 250 and any other FPD sheets it is to process. Accordingly, the machine 210 can retrieve the error map and/or error function from its local memory on loading of the FPD sheet. The error map and/or error function for the FPD sheet 250 could be combined with any previously generated error map(s) and/or error function(s) for the machine thereby enabling errors caused by the machine configuration and also by the FPD sheet's 250 first 254 and second 256 scales to be compensated for.

The machine 210 then at step 410 processes the FPD sheet 250 in accordance with its predetermined routine. For example, the machine could use the tool 222 to inject liquid crystal into individual cells/pixels in one or more of the regions 252, inspecting one or more of the regions 252 for faults/defects, for instance via obtaining at least one images of at least a part of a region 252, and/or repair at least a part of a region 252, e.g. using a laser to remove a broken pixel. As will be understood, this will involve movement of the tool 222 relative to the FPD sheet 250 in order to locate the tool in the appropriate place. During the processing operation the position of the tool 222 relative to the FPD sheet 250 in the y-axis is monitored using the outputs of the first 226 and second 228 readheads which read the first 254 and second 256 scales printed on the FPD sheet 250. The error map and/or error function is used to correct the measurements obtained via the first 226 and second 228 readheads. As the position is being measured directly off the FPD sheet 250 itself the position of the tool 222 relative to the FPD sheet 250 is accurately known in the y-dimension, even if the FPD sheet 250 moves relative to the platform, and/or undergoes thermal expansion/contraction prior to and/or during the processing operation. Furthermore, it may be that there is a preferred location of the FPD sheet 250 on the platform 212 in the y-dimension. Any offset of the FPD sheet 250 from the preferred location can be determined from the first 254 and second 256 scales on the FPD sheet itself. Depending on the machine setup, this may also require information from encoders/position sensors on the machine itself. Any such longitudinal offset can be reduced or eliminated by moving the FPD sheet 250 back to the preferred location using the first 254 and second 256 scales, and/or the offset can be automatically compensated by the control system 230.

Once the processing of the FPD sheet 250 on the machine 210 is complete it is determined at step 412 if the FPD sheet 250 requires more processing on a subsequent machine. Indeed, the FPD sheet 250 could be required to be processed by many machines similar to that shown in FIG. 2, each of which is configured to perform its own processing task(s). For instance, one machine may be configured to inject liquid crystal into pixels of a region 252, another to inspect the pixels of a region 252, and another to repair pixels of a region 252. As will be understood, these are only examples and there could be many tens of such machines in a FPD manufacturing line.

If processing is required on a subsequent machine, then the FPD sheet 250 is loaded onto the next machine (either manually or automatically as described above in connection with the loading of the FPD sheet 250 onto the first machine 210) at step 414. This subsequent machine then retrieves the error map and/or error function at step 408 (for example from a central sever or from a local memory device) and processes the FPD sheet 250 in accordance with its dedicated processing operation at step 410. In line with the above this involves the subsequent machine determining position of any such tool on the gantry relative to the FPD sheet in the y-axis via the outputs of the first 226 and second 228 readheads (which are corrected using the error map and/or error function). Steps 408 to 414 continue until all processing of the FPD sheet 250 is complete by the last machine in the manufacturing line.

FIG. 5 shows an alternative embodiment in the invention, similar to that shown in FIG. 2, and like parts share like reference numerals. The embodiment shown in FIG. 5 differs to that shown in FIG. 2 in that the FPD sheet 350 only has one scale 254 provided along one of its edges. As will be understood, only one scale is needed in order to track the relative position of the tool 222 and FPD sheet 350 in the y-dimension. Nevertheless as explained in more detail below the provision of two scales, one on each opposing edge of the FPD sheet 250, 350, can be useful in order to provide more accurate measurements of the relative position of the tool and FPD sheet, especially when the sheet is not perfectly aligned on the platform 212. The embodiment of FIG. 5 also differs in that the readhead 226 for reading the scale 254 is mounted on the upright pillar 216 of the gantry 214 via an arm 352. The arm 352 is mounted to the upright pillar 216 via a pivot joint such that the readhead 226 can be swung away from its reading position in the direction shown by arrow A. Such retraction of the readhead 226 can aid loading/unloading of the FPD sheet 350 onto the platform 212 as well as maintenance (e.g. cleaning) of the machine 310 and readhead 226. As will be understood, one or both of the readheads 226, 228 shown in the embodiment of FIG. 2 can be mounted on the gantry 214 via such retractable arms.

FIG. 6 shows a plan view of a FPD sheet 450 according to another embodiment of the invention. Like with the embodiment shown in FIGS. 2 and 3, the FPD sheet 450 comprises a plurality of FPD areas 252 and first 254 and second 256 scales extending along opposing longitudinal edges of the FPD sheet 450. However, the FPD sheet 450 shown in FIG. 6 also comprises a third scale 452 which extends orthogonal to the first 254 and second 256 scales, part way across the width of the FPD sheet 450 at one of its ends. This can be read by a readhead mounted on a fixed arm which is attached to the gantry, in particular to a vertical pillar 116 of the machine so as to enable the lateral position of the FPD sheet 450 loaded on the platform of a machine to be determined prior to commencing any processing of the FPD sheet. Accordingly, any lateral offset of the FPD sheet 450 can be compensated for using the third scale 452. As will be understood, in other embodiments, the readhead for the third scale 452 could be provided on the tool holder 120 or even on the platform 112. Furthermore, the third scale 452 could extend across a greater proportion of the width of the FPD sheet 250, for instance the entire width of the FPD sheet 250. The third scale 452 also need not necessarily be placed at the end of the FPD sheet 250. For instance it could be placed halfway along the FPD sheet 250, e.g. between the regions 252. The same also applies to the first 254 and second 256 scales, e.g. they need not be placed at the edges of the FPD sheet 250, but could be placed away from edges, for instance between the regions 252. In a yet further embodiment a two-dimension scale could be formed on the FPD sheet 250 which can be used to provide position information in both the x and y dimensions. For example, a grid-like scale could be provided on the underside of the FPD sheet 250 and read by at least one readhead located underneath the FPD sheet 250, e.g. in the platform. The two-dimensional scale could be configured such that it can be removed from the FPD sheet 250, e.g. the scale could be a temporary scale which could be washed off after the regions 252 have been processed using chemicals.

FIG. 7 illustrates a plan view of the FPD sheet 250 of FIGS. 2 and 3 loaded on the platform 212 of the machine 210 (for the sake of simplicity, the gantry 214 is not shown in FIG. 7, but the first 226 and second 228 readheads are). As can be seen, the FPD sheet 250 has been loaded on the platform in such a way that it is rotationally offset about an axis perpendicular to the plane of the platform. However, the fact that the FPD sheet 250 is rotationally offset and the angle of rotational offset can be determined by the outputs of the first 226 and second 228 readheads. Indeed, as shown in FIG. 7, due to the rotational offset the first and second 228 readheads will be at different points along the lengths of the first 254 and second 256 scales, and that difference can be used to determine the angle of rotational offset θ (e.g. the angle between a line 260 extending perpendicularly between the longitudinal sides of the FPD sheet 250 and a line 262 extending perpendicularly between the first 226 and second 228 readheads as shown in FIG. 7). The position of the FPD sheet 250 could then be adjusted to reduce or eliminate the rotational offset and/or the control system 230 can determine and read the offset, calculate any positional error and compensate for the rotational offset during the processing operation. Whether the rotational offset is merely compensated for by the control system 230 or the rotational offset is reduced by moving the FPD sheet 250 can be based on the maximum offset that can be compensated without the readheads laterally running off the scales (which in turn can depend on the size of the readhead window and the width of the scale).

FIG. 8 shows an alternative embodiment of the invention in which a plurality of components are made on a flexible substrate 300, each component being made in a component area 302 on the substrate. The components are manufactured on a reel-to-reel processing machine and accordingly the substrate is supported by and is moved via a series of reels, or rollers, 304 on the machine as opposed to a platform as shown in the other embodiments described above. The reel-to-reel processing machine also has a substrate processing part (not shown), such as a tool similar to those described above in connection with the other embodiments of the invention, for processing at least one component area (e.g. via inspection or by operating on the at least one component area) at at least one stage along the reel-to-reel process. A metrological scale 306 substantially the same as that described above in connection with the other embodiments is provided on the flexible substrate 300 and extends along the length of the substrate 300 in a first dimension. A readhead (not shown) associated with the substrate processing part is provided which reads the metrological scale 306 so as to enable the relative position of the substrate processing part and the substrate 300 to be determined.

In the embodiments described above, the first 254 and second 256 scales define a series of absolute positions, and are commonly known as absolute scale, for instance as described in U.S. Pat. No. 7,499,827 and U.S. Pat. No. 5,279,044. However, this need not necessarily be the case. For instance the first 254 and/or second 256 scales could comprise incremental scales (with or without reference mark positions), for instance as described in U.S. Pat. No. 4,974,962 and U.S. Pat. No. 7,659,992.

In the embodiments described above, the first 254 and second 256 scales are provided by a continuous series of features. However, as will be understood, this need not necessarily be the case. For instance, the first 254 and second 256 scales could be provided by a series of distinct groups of scale features spaced along the length of the FPD glass. For instance, there could be gaps in the first 254 and second 256 scales, e.g. at gaps between the different regions 252.

In the embodiments described above the scales have been formed on the topside of the FPD sheet 250, that is the side of the FPD sheet 250 that is processed by the machine on which it is loaded. Nevertheless, the scales could be formed on the underside of the FPD sheet 250. In this case the readheads could be configured to read the scale through the FPD sheet 250 or could be located such that they read the scale from underneath the FPD sheet 250. In a further embodiment, at least one of the scales could be provided on the vertical edges of the FPD sheet 250, i.e. on the rim of the FPD sheet 250.

Furthermore, in the embodiments described above the scales are formed permanently on the FPD sheet 250. They do not interfere with the final product formed in the regions 250 because they are not located in the regions 252. In other embodiments, the scales could be formed temporarily on the FPD sheet 250, e.g. by printing the scales on the FPD sheet 250 using non-permanent ink. After processing, the scale markings could be removed by washing using appropriate chemicals. This can enable the scales to be located anywhere on the FPD sheet 250, including in the regions 252 themselves.

Furthermore, the above described embodiments describe a plurality of regions 252 being provided on an FPD sheet 250. However, as will be understood, there could be as few as one region provided on the FPD sheet 250.

Further still, the above described embodiments comprise first (and optionally second) scales 254, 306 (256) that are used for all of the regions 252, 302 on the substrate 250, 300. However, as will be understood, there could be provided separate scales for different regions 252, 302. For instance, there could be provided one individual scale for each region 252, 302. Optionally, there could be provided at least one scale for at first group of regions and at least one other scale for a second group of regions.

1. A method of manufacturing at least one component in at least one component area on a substrate using a machine that has a substrate processing part relatively moveable with respect to the substrate, the method comprising:
at least when the substrate processing part and substrate are in a positional relationship in which the substrate processing part can process the at least one component area on said substrate, measuring the position of the substrate processing part relative to the substrate, by reading at least a first metro logical scale provided by the substrate.

2. A method as claimed in claim 1, comprising monitoring the relative position of the substrate processing part and the substrate using the at least first metrological scale.

3. A method as claimed in claim 1, in which the method comprises a control system receiving position information from a position sensor on the machine reading the at least first metrological scale, and controlling the relative movement of the substrate processing part of the machine and the substrate based on said position information.

4. A method as claimed in claim 1, further comprising forming said at least first metrological scale on said substrate.

5. A method as claimed in claim 1, further comprising, creating an error map and/or error function for said at least first metrological scale, and using said error map or said error function to correct measurements of the relative position of the substrate processing part of the machine and the substrate.

6. A method as claimed in claim 1, comprising at least when a second substrate processing part and the substrate are in a positional relationship in which the second substrate processing part can process the at least one component area on said substrate, measuring the position of the second substrate processing part relative to the substrate, by reading at least a first metrological scale provided by the substrate.

7. A method as claimed in claim 1, in which the substrate comprises at least a first auxiliary metrological scale comprising a series of position markings extending in a different direction to that of the first metrological scale.

8. A method as claimed in claim 7, in which the first auxiliary metrological scale comprising a series f position markings extending orthogonally to the first metrological scale.

9. A method as claimed in claim 1, in which the series of position markings define absolute position information.

10. A method as claimed in claim 1, in which the substrate comprises a plurality of component areas and in which for at least first and second positional relationships in which the substrate processing part can respectively process first and second component area on said substrate, measuring the position of the substrate processing part relative to the substrate by reading at least a first metrological scale provided by the substrate.

11. A method as claimed in claim 1, in which the substrate comprises a flat panel display sheet and in which a component area comprises a flat panel display area in which a flat panel display is to be made.

12. A method as claimed in claim 1, in which the substrate comprises a flexible substrate.

13. A method as claimed in claim 12, in which the machine comprises a reel-to-reel processing machine, comprising a plurality of reels between which the flexible substrate is passed relative to the at least one substrate processing part.

14. A method as claimed in claim 1 in which the at least first metrological scale comprises a series of markings formed directly on and/or in the substrate.

15. An apparatus for manufacturing at least one component on a substrate, comprising:
a machine comprising a substrate processing part for processing at least one component area of a substrate, the substrate processing part and substrate being movable relative to each other such that they can be moved into a positional relationship in which the substrate processing part can process the at least one component area on said substrate;
at least one position sensor configured such that when the substrate processing part and substrate are in such a positional relationship, the position sensor can read a scale provided by the substrate; and
a control system configured to receive such readings from the at least one position sensor and to measure the relative position of the substrate processing part and the at least one component area.

16. A substrate comprising at least one component area which is to be made into at least one component, the substrate having at least a first metrological scale extending along the substrate in a first dimension by at least the same length as the length of the at least one component area taken in the first dimension such that the at least first metrological scale can be read when a substrate processing part is in a positional relationship relative to the substrate for processing the at least one component area so as to measure their relative position.

17. A substrate as claimed in claim 16, in which the substrate comprises a flat panel display substrate comprising at least one flat panel display area which is to be made into a flat panel display.

18. A substrate as claimed in claim 16, in which the substrate comprises at least a first auxiliary metrological scale comprising a series of position markings extending orthogonally to the first metrological scale.

19. A substrate as claimed in claim 16, in which the scale comprises a series of absolute position markings that define a plurality of unique positions along the length of the scale.

20. A method of manufacturing a component comprising:
taking a substrate comprising at least one component area, the substrate having at least a first metrological scale comprising a series of position markings extending along the substrate;
in which the at least first metrological scale is used to monitor the relative position of the substrate and a substrate processing part of a machine that is used to process at least one of the at least one component areas.

21. A method of manufacturing at least one component in at least one component area on a substrate comprising forming at least a first metrological scale on the substrate which extends along the substrate in a first dimension by at least the same length as the length of the at least one component area taken in the first dimension.

22. A method of manufacture, comprising:
generating an error map and/or error function for a metrological scale located on a substrate;
loading the substrate onto at least one machine for processing, and supplying the error map and/or error function for the substrate's scale to the at least one machine;
the machine using the substrate's scale and the error map and/or error function during processing of the workpiece.

23. A method as claimed in claim 22, in which during manufacture of the
substrate, the substrate is loaded onto a plurality of machines which use the substrate's scale during processing of the workpiece.

24. A method as claimed in claim 23, comprising supplying the error map and/or error function to a plurality of those machines for use during processing said substrate.
